(19) United States
(12) Patent Application Publication
(10) Pub. No.: US 2005/0148308 A1
(43) Pub. Date: Jul. 7, 2005

(54) Amplification apparatus, systems, and methods

(76) Inventor: Luiz M. Franca-Neto, Sunnyvale, CA (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/749,927

(22) Filed: Dec. 29, 2003

(51) Int. Cl. H04B 1/02

(52) U.S. Cl. 455/108; 455/116

(57) ABSTRACT

An apparatus and a system, as well as a method and an article, may include adjusting a duty cycle of a switching amplifier input by changing the amplitude of an analog message signal to provide a modulated carrier having a monotonically-increasing fundamental frequency component.

### RELATED APPLICATIONS

This disclosure is related to pending U.S. patent application Ser. No. ______ (Attorney Docket 884.B62US1), titled “Component Packaging Apparatus, Systems, and Methods”, by Luiz M. Franca-Neto, filed on Dec. 18, 2003, and is assigned to the assignee of the embodiments disclosed herein, Intel Corporation.

### TECHNICAL FIELD

Various embodiments described herein relate to communications generally, including apparatus, systems, and methods for modulating and amplifying communications signals.

### BACKGROUND INFORMATION

Traditional multiple carrier communication techniques, such as orthogonal frequency division multiplexing (OFDM), may require linear power amplification (e.g., Class A) to transmit signals through space. However, more efficient power amplifiers (e.g., Class D and E amplifiers) may favor switching operation, which does not utilize amplitude information directly.

Consumers continue to demand longer operational times and reduced battery usage in various appliances, such as cellular telephones and other wireless communication systems that make use of multiple carrier communication techniques. Thus, there is a need to develop efficient amplifiers capable of attending to the modulation requirements of complex constellation signaling.

### BRIEF DESCRIPTION OF THE DRAWINGS

FIG. 1 is a block diagram of an apparatus and a system according to various embodiments;

FIG. 2 is a schematic diagram of an apparatus and a system according to various embodiments;

FIG. 3 is a flow chart illustrating several methods according to various embodiments; and

FIG. 4 is a block diagram of an article according to various embodiments.

### DETAILED DESCRIPTION

Various embodiments disclosed herein address some of the challenges described above by translating analog message amplitude information into switching amplifier duty cycle information. Thus, in some embodiments, a unique modulator is provided, enabling the use of switching amplifiers to transmit quadrature amplitude modulation (QAM)-OFDM signals without the need for a separate mixer.

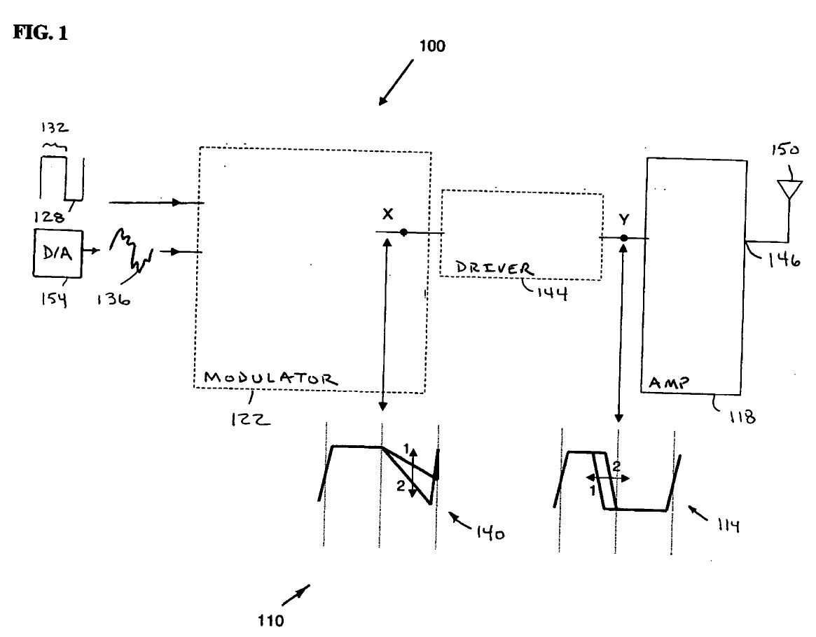

FIG. 1 is a block diagram of an apparatus 100 and a system 110 according to various embodiments, each of which may operate in the manner described. As the duty cycle of a square wave modulated carrier 114 input to a switching amplifier 118 changes, so does the harmonic content of the square wave. For example, the square wave can be viewed as having a number of substantially sinusoidal wave components, including a fundamental frequency component and a number of odd harmonic components. The amplitude of the fundamental frequency component may increase in a monotonic fashion, and it may reach a maximum value when the square wave assumes a 50% duty cycle. At duty cycles of greater percentage, the amplitude of the fundamental frequency component may decrease.

The average direct current (DC) level of the square wave, however, may increase in direct proportion to the duty cycle, up to a duty cycle of 100%. This DC component may be used, for example, to drive speakers coupled to switching audio signal amplifiers. However, with respect to the embodiments disclosed herein, it is the amplitude of the square wave fundamental frequency component that is used, since a modulated carrier is desired.

Thus, an information signal can be used to modulate the duty cycle of a square wave. Changing the duty cycle of a square wave may change its spectrum content. The DC level and fundamental frequency components of a duty-cycle-modulated square wave may therefore change in accordance with the modulating information signal.

In audio applications, the power amplifier and speakers define a low pass filter response which converts the modulation of the DC component of the duty-cycle-modulated square wave into sound. However, in many of the embodiments disclosed herein, one or more power amplifiers and an antenna define a band pass filter response tuned to the fundamental frequency of the modulated square wave, which transmits (radiates) the modulation of the fundamental frequency component of the duty-cycle-modulated square wave. Pre-distortion may be used to compensate for non-linear response of the modulation (which may occur because the amplitude of the fundamental frequency component of the duty-cycle-modulated square wave tends to peak at about a 50% duty cycle, compressing the information to be transmitted when large amplitudes are present).

Therefore, as shown in FIG. 1, an apparatus 100 may include a modulator 122 having a clock input 128 including a duty cycle 132 to be modulated by an analog message signal 136. For the purposes of this disclosure, an “analog message signal” is any electronic signal provided in a continuous (non-sampled) fashion that carries information, including symbols or other data, capable of being communicated from one electronic device to another.

The modulator 122 may be used to provide a modulated carrier 114 with a monotonically-increasing fundamental frequency component to a switching amplifier 118, such as a class D, class E, or class S amplifier, among others. In some embodiments, the apparatus 100 may include a duty cycle modulator 122 to sink a clock input 128 according to the level of the analog message signal 136 to provide a modulated carrier with a monotonically-increasing fundamental frequency component to the switching amplifier 118. In other words, the duty cycle modulator 122 may be used to raise and lower the mean value of a sinusoidal signal according to the level of the analog message signal 136 to provide a modulated signal with a monotonically-increasing fundamental frequency component to the switching amplifier 118. The duty cycle may be limited to less than about 50%, and in some embodiments, the duty cycle may be limited to less than about 30% (e.g., to improve the linearity of the amplifier output).

The apparatus 100 may operate over a wide range of carrier frequencies. The frequency of operation may be limited by the speed of the technology used to implement some embodiments. For example, if 100 nm CMOS technology is used, experimentation verifies that operation up to about 5 GHz may be enabled. This is because lower transmitted power tends to accompany a smaller duty cycle. Thus, to generate a 5% duty cycle with a 10 GHz square-wave signal, for example, a 100 GHz clock may be required. In many embodiments, the clock input 128 may include a frequency of about 500 MHz to about 100 GHz.

As the duty cycle of the clock input 128 is modulated by the analog message signal 136, the modulator output signal 140 (shown as measured at point X) may be used as an input to a driver 144, providing a clean transition signal source for the modulated carrier 114 (shown as measured at point Y). The output of the amplifier 118, in turn, may be coupled to an antenna 150, such as a patch, monopole, dipole, beam, array, or directional antenna, among others. The analog message signal 136 may include one or more QAM symbols, and the output of the amplifier 118 may form part of a multiple carrier communication system, including an OFDM system.

Assuming certain types of signals are processed by the amplifier 118 (e.g., complex constellations of symbols included in multiple carrier signaling), some of the signals at the amplifier output 146 may suffer amplitude compression. For example, signals representing large peak-to-average ratio symbols may be smoothly rounded, or even clipped at the amplifier output 146. However, if desired, the amplifier output 146 may be linearized in several ways. First, the duty cycle of the modulated carrier 114 may be limited to less than about 30%, as described above. Second, signaling symbols present in the analog message signal 136 may be pre-distorted. In some embodiments, the output of a digital-to-analog (D/A) converter may be selectively pre-distorted according to one or more functions implemented in the D/A converter design. Such a pre-distorted output may be used to provide the analog message signal 136. Still further embodiments may be realized.

For example, a system 110 may include an apparatus 100 as described previously, as well as a switching amplifier 118, such as a switching power amplifier, to receive the modulated carrier 114. As noted above, any number of antennas 150 may be coupled to the amplifier 118, including a monopole antenna. The switching amplifier 118 may be selected from a class D amplifier, a class E amplifier, or a class S amplifier, among others.

The amplifier 118 may be coupled to the modulator 122 directly, or by using a driver 144. The driver 144 may provide sharp rail-to-rail transitions of the modulated carrier 114, for example, as can be produced by one or more complementary metal-oxide semiconductor (CMOS) inverters. Some current implementations of sub-100 nm CMOS switching technology are fast enough to support the designs disclosed herein, perhaps as part of a 5.2 GHz industrial, scientific, and medical (ISM) band wireless local area network (LAN). As CMOS technology evolves, even higher operating frequencies may be enabled by the embodiments disclosed herein.

Thus, in some embodiments, a system 110 may include a driver 144 to directly couple the modulator 122 to the switching amplifier 118. In some embodiments, a digital-to-analog converter 154 may be used to provide the analog message signal 136.

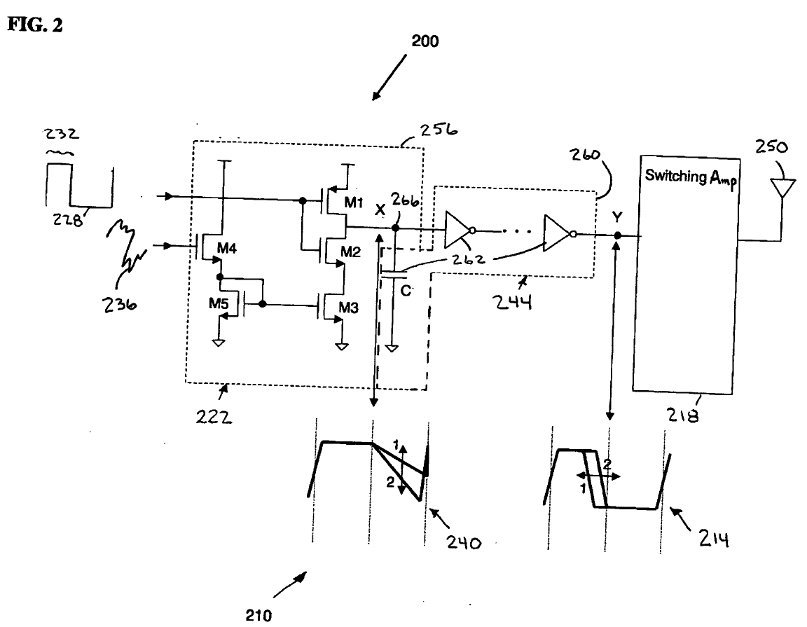

FIG. 2 is a schematic diagram of an apparatus 200 and a system 210 according to various embodiments. In this case, component details for several possible embodiments are illustrated. The apparatus 200 and system 210 may be similar to or identical to the apparatus 100 and system 110, respectively (see FIG. 1).

The apparatus 200 may include a die 256 having one or more scalable components (e.g, transistors M1 . . . M6) of a modulator 222. The apparatus 100 may also include a structure 260, such as a package substrate, having one or more non-scalable components 262 of the modulator 222. The die 256 may be fabricated so that it does not include any non-scalable components 262 of the modulator 222. Power, ground, and other signals may be routed from the external world to the modulator 222 via a variety of nodes 266, which may include controlled collapse chip connections.

The scalable components (e.g., transistors M1 . . . M6) may include one or more diodes, and/or transistors, including FETs. Non-scalable components 262 may include one or more transformers, transmission lines, inductors (e.g., radio frequency chokes), capacitors C, and/or resistors, each of which may in turn include one or more traces (e.g., microstrip or striplines) forming a part of the structure 260. In some embodiments, all of the passive components of a switching power amplifier may be included in the structure 260, while all of the scalable components may be included in the die 256.

As shown in FIG. 2, in some embodiments, the clock input 228 may be used to initiate alternately charging and discharging the capacitor C. The rate of charging the capacitor C may be influenced by the size of the transistor M1 and the size of the capacitor C. The rate of discharging the capacitor C may be limited by the design of the current-source transistor M3, having a current drive level defined by the amplitude of the analog message signal 236.

The amplitude or voltage level of the analog message signal 236 may pass from the input of the modulator 222 to the gate of the transistor M3 in a substantially linear fashion. The transistor M3 may operate to convert voltage to current in accordance with square-law principles, well-known to those of skill in the art. Such operation may act to decompress larger amplitudes in the modulator output signal 240. The activity of decompressing the modulator output signal 240 may compensate, to some extent, for compression that may occur as a result of processing greater amplitudes of the analog message signal 236 by the amplifier 218 as the duty cycle 232 of the clock input 228 is modulated. Non-linearity provided by the transistor M3 may operate to diminish the level of pre-distortion applied to QAM signals present in the analog message signal 236, as desired for linearizing the output of the amplifier 218. Simulation of modulator 222 operations may be used to determine actual values for the design of the transistors M1 . . . M6 and the capacitor C.

It should be noted that no separate mixer may be needed in the transmission chain, since the switching amplifier 218 may be driven directly by a modulated carrier 214 derived from a clock input 228 having a duty cycle 232 adjusted by the amplitude of the analog message signal 236. In some embodiments, the modulator output signal 240 (as measured at point X) may transition to a logic low level faster or slower depending on the amplitude level of the analog message signal 236. The greater the amplitude of the analog message signal 236, the faster the modulator output signal 240 may transition to a logic low level, and the greater may become the duty cycle of the modulated carrier 214 (as measured at point Y). As noted previously, in some embodiments, the modulator 222 may be designed to sink the modulator output signal 240 to a level determined by the amplitude or voltage level of the analog message signal 236.

In some embodiments, feedback can be provided to enable automatic adjustment of the analog message signal 236 amplitude. For example, referring back to FIG. 1, this mechanism may be implemented by manipulating the output of the digital-to-analog converter 154 so as to avoid compressing the analog message signal 136 unnecessarily towards the 50% duty cycle regime.

Thus, in some embodiments, an apparatus 200 may include a clock input 228 that is used to initiate charging and discharging of a capacitor C. The rate of discharge of the capacitor C may be controlled by the analog message signal 236, including the amplitude or voltage level of the analog message signal 236. As noted previously, the analog message signal 236 may include a plurality of QAM symbols. In some embodiments, an apparatus 200 may include a duty cycle modulator 222 to sink the clock input 228 according to the level of the analog message signal 236 to provide a modulated carrier 214 with a monotonically-increasing fundamental frequency component to the switching amplifier 218. In many embodiments, the duty cycle of the modulated carrier 214 may be limited to less than about 50%.

The apparatus 100, 200, systems 110, 210, modulated carriers 114, 214, switching amplifiers 118, 218, modulators 122, 222, clock inputs 128, 228, duty cycles 132, 232, analog message signals 136, 236, modulator output signals 140, 240, amplifier output 146, antennas 150, 250, drivers 144, 244, die 256, structure 260, non-scalable components 262, nodes 266, capacitor C, and scalable components M1 . . . M6, may all be characterized as “modules” herein. Such modules may include hardware circuitry, and/or a processor and/or memory circuits, software program modules and objects, and/or firmware, and combinations thereof, as desired by the architect of the apparatus 100, 200, and systems 110, 210, and as appropriate for particular implementations of various embodiments. For example, such modules may be included in a system operation simulation package, such as a software electrical signal simulation package, a power usage and distribution simulation package, a capacitance-inductance simulation package, a power/heat dissipation simulation package, and/or a combination of software and hardware used to simulate the operation of various potential embodiments.

It should also be understood that the apparatus and systems of various embodiments can be used in applications other than for cellular telephones, and other than for systems that include wireless data communications, and thus, various embodiments are not to be so limited. The illustrations of apparatus 100, 200 and systems 110, 210 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, workstations, radios, video players, vehicles, and others. Some embodiments include a number of methods.

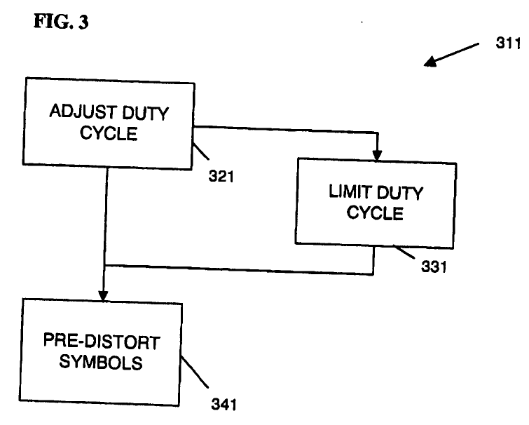

For example, FIG. 3 is a flow chart illustrating several methods 311 according to various embodiments. For example, a method 311 may (optionally) begin at block 321 with adjusting a duty cycle of a switching amplifier input by changing an amplitude of an analog message signal to provide a modulated carrier having a monotonically-increasing fundamental frequency component. Adjusting the duty cycle may further include limiting the duty cycle to less than about 50% at block 331. In some embodiments, adjusting the duty cycle may further include limiting the duty cycle to less than about 30% at block 331.

As noted previously, the amplitude of the analog message signal may change according to a multiple carrier communication technique, and the multiple carrier communication technique may include an OFDM process. Thus, the method 311 may include pre-distorting a QAM signal included in the analog message signal to control non-linearity associated with the switching amplifier at block 341. For example, the method 311 may include pre-distorting a QAM signal included in the analog message signal to compensate non-linearity associated with the switching amplifier. The method 311 may also include pre-distorting the final OFDM output signal by pre-distorting the output of a D/A converter is noted above. Thus, the method 311 may include pre-distorting an OFDM signal included in the analog message signal to compensate non-linearity associated with the switching amplifier.

It should be noted that the methods described herein do not have to be executed in the order described, or in any particular order. Moreover, various activities described with respect to the methods identified herein can be executed in serial or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer-readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as assembly or C. The software components may communicate using any of a number of mechanisms well known to those skilled in the art, such as application program interfaces or interprocess communication techniques, including remote procedure calls. The teachings of various embodiments are not limited to any particular programming language or environment, including Hypertext Markup Language (HTML) and Extensible Markup Language (XML). Thus, other embodiments may be realized.

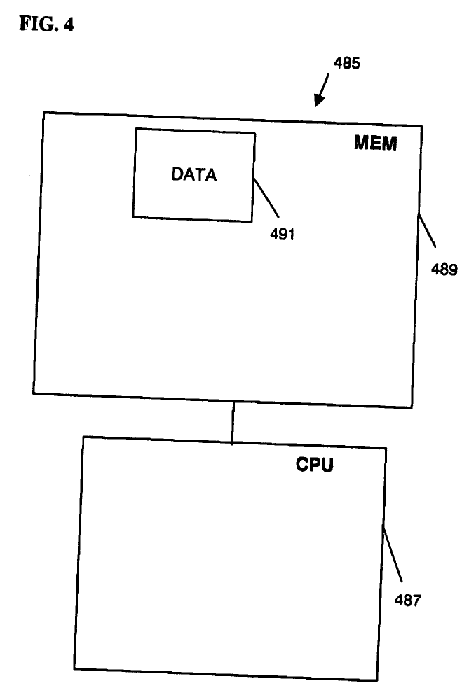

FIG. 4 is a block diagram of an article 485 according to various embodiments, such as a computer, a memory system, a magnetic or optical disk, some other storage device, and/or any type of electronic device or system. The article 485 may include a processor 487 coupled to a machine-accessible medium such as a memory 489 (e.g., a memory including an electrical, optical, or electromagnetic conductor) having associated information 491 (e.g., computer program instructions and/or data), which when accessed, results in a machine (e.g., the processor 487) performing such actions as adjusting a duty cycle of a switching amplifier input by changing an amplitude of an analog message signal to provide a modulated carrier having a monotonically-increasing fundamental frequency component. Other activities, for example, may include limiting the duty cycle to less than about 50%, as well as pre-distorting a QAM signal included in the analog message signal to compensate non-linearity associated with the switching amplifier, or pre-distorting the OFDM signal included in the analog message signal to compensate non-linearity associated with the switching amplifier (e.g., when multiple QAM carriers are included in the final OFDM signal). Pre-distortion may be included in the analog message signal processing to control non-linearity associated with the switching amplifier, perhaps supplied by a D/A converter having a pre-distorted output, as mentioned above.

Improved integration of RF circuitry, including scalable portions of transceivers, power amplifiers, and digital processors on the same die may result after implementing the apparatus, systems, and methods disclosed herein. Some embodiments may be constructed so as to have only transistors remaining on-die, permitting further integration of high-performance, high-power CMOS integrated radios, including fully-scalable dice forming part of a single package, such as a flip-chip package. In addition, the apparatus, systems, and methods disclosed may enable more efficient use of multiple carrier communications systems (e.g., signal transmission using class D or E amplifiers instead of class A amplifiers).

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. An apparatus, including:
a modulator having a clock input including a duty cycle to be modulated by an analog message signal, the modulator to provide a modulated carrier with a monotonically-increasing fundamental frequency component to a switching amplifier.

2. The apparatus of claim 1, wherein the duty cycle is limited to less than about 50%.

3. The apparatus of claim 1, wherein the clock input includes a frequency of about 500 MHz to about 100 GHz.

4. The apparatus of claim 1, wherein the clock input is used to initiate charging and discharging of a capacitor.

5. The apparatus of claim 4, wherein a rate of discharge of the capacitor is controlled by the analog message signal.

6. The apparatus of claim 1, wherein the analog message signal includes a plurality of quadrature amplitude modulated symbols.

7. An apparatus, including:
a duty cycle modulator to raise and lower the mean value of a sinusoidal signal according to a level of an analog message signal to provide a modulated signal with a monotonically-increasing fundamental frequency component to a switching amplifier.

8. The apparatus of claim 7, wherein the duty cycle is limited to less than about 50%.

9. The apparatus of claim 7, wherein the analog message signal includes quadrature amplitude modulated symbols.

10. A system, including:
a modulator having a clock input including a duty cycle to be modulated by an analog message signal, the modulator to provide a modulated carrier with a monotonically-increasing fundamental frequency component; and
a switching power amplifier to receive the modulated carrier and coupled to the modulator.

11. The system of claim 10, further including:
a monopole antenna to couple to the switching power amplifier.

12. The system of claim 10, wherein the switching power amplifier is selected from a class D amplifier, a class E amplifier, and a class S amplifier.

13. The system of claim 10, further including:
a driver to directly couple the modulator to the switching power amplifier.

14. The system of claim 10, further including:
a digital-to-analog converter to provide the analog message signal.

15. A method, including:
adjusting a duty cycle of a switching amplifier input by changing an amplitude of an analog message signal to provide a modulated carrier having a monotonically-increasing fundamental frequency component.

16. The method of claim 15, wherein adjusting the duty cycle further includes:
limiting the duty cycle to less than about 50%.

17. The method of claim 15, wherein the amplitude of the analog message signal changes according to a multiple carrier communication technique.

18. The method of claim 17, wherein the multiple carrier communication technique includes an orthogonal frequency division multiplexing (OFDM) process.

19. The method of claim 15, further including:
pre-distorting a quadrature amplitude modulation (QAM) signal included in the analog message signal to compensate non-linearity associated with the switching amplifier.

20. The method of claim 15, further including:
pre-distorting an orthogonal frequency division multiplexed signal included in the analog message signal to compensate non-linearity associated with the switching amplifier.

21. An article comprising a machine-accessible medium having associated information, wherein the information, when accessed, results in a machine performing:
adjusting a duty cycle of a switching amplifier input by changing an amplitude of an analog message signal to provide a modulated carrier having a monotonically-increasing fundamental frequency component.

22. The article of claim 21, wherein adjusting the duty cycle further includes:
limiting the duty cycle to less than about 50%.

23. The article of claim 21, wherein the analog message signal includes quadrature amplitude modulated (QAM) symbols, and wherein the information, when accessed, results in the machine performing:
pre-distorting a quadrature amplitude modulation (QAM) signal included in the analog message signal to compensate non-linearity associated with the switching amplifier.

24. The article of claim 24, wherein the analog message signal includes an orthogonal frequency division multiplexed (OFDM) signal, and wherein the information, when accessed, results in the machine performing:
pre-distorting the OFDM signal included in the analog message signal to compensate non-linearity associated with the switching amplifier.
